(19) United States
(12) Patent Application Publication
(10) Pub. No.: US 2013/0333599 A1
(43) Pub. Date: Dec. 19, 2013

(54) Row Crop Planter Having Closing Wheel With Modular Wheel Design

(71) Applicants: Joseph D. Bassett, Sycamore, IL (US); Justin Landeck, Maple Park, IL (US); Rodney J. Arthur, DeKalb, IL (US)

(72) Inventors: Joseph D. Bassett, Sycamore, IL (US); Justin Landeck, Maple Park, IL (US); Rodney J. Arthur, DeKalb, IL (US)

(73) Assignee: DAWN EQUIPMENT COMPANY, Sycamore, IL (US)

(21) Appl. No.: 13/523,557

(22) Filed: Jun. 14, 2012

(51) Int. Cl. A01C 13/00; A01C 7/18

(52) U.S. Cl. 111/62

(57) ABSTRACT

An agricultural row unit includes a towing frame, an attachment frame, and a linkage. A row unit frame has a forward end coupled to the linkage to permit vertical pivoting movement of the row unit frame relative to the attachment frame. A closing-wheel assembly includes a support arm having a leading end coupled to the row unit frame, and a hub assembly mounted at a trailing end of the support arm. The hub assembly has a wheel-fastening mechanism with one or more removable fasteners. The closing-wheel assembly further includes a closing wheel connected to the hub assembly with the one or more removable fasteners such that the closing wheel is interchangeable with different types of modular closing wheels.

### FIELD OF THE INVENTION

The present invention relates generally to agricultural equipment and, more particularly, to a row crop planter having a modular wheel design for receiving different types of closing wheels.

### BACKGROUND OF THE INVENTION

In agricultural applications, farmers have typically used row crop planters with a single or double disk opener for opening a trench, roughly of a parabolic cross-section, in which seed is deposited. Traditionally, over many decades, a Vee-type closing wheel has been used in conventional tillage equipment for closing the trench. While most farmers still use conventional tillage equipment, various minimum-tillage systems and no-till systems have gained popularity over the past 20 years.

Based on the different tillage systems, and to achieve optimum results, the agricultural industry has recognized a need for using different closing wheel designs for various soil conditions. For example, a smooth semi-pneumatic rubber wheel has been used virtually since the onset of corn farming to the present day. With the advent of no-till farming, numerous other types of closing wheels have been marketed to address specific needs of planted seeds (e.g., corn seed), as well as non-optimal soil conditions.

One popular type of closing wheel is a toothed closed wheel, which has become a dominant type of closing wheel in both no-till and conventional farming. However, availability of different types of toothed closing wheels presents additional problems because each type of wheel is directed to limited planting applications. For example, corn planting requires seed-to-soil contact in which sufficient weight must be applied on the seed to ensure firming of the seed into the soil. Certain toothed wheel designs tend to be optimized for a limited range of conditions and seed depths. As such, different toothed wheels are required by different levels of tillage.

Another factor that affects selection of different closing wheels is causes by levels of soil “stickiness.” Different soil conditions can cause many different levels of “stickiness” that result in different tendencies of soil adherence to the closing wheel. The different soil adherence alters performance of the closing wheels, and, accordingly, different types of closing wheels are selected to increase the performance of the closing wheels based on the soil conditions.

### SUMMARY OF THE INVENTION

In accordance with one embodiment, an agricultural row unit includes a towing frame for being coupled to a tractor, an attachment frame adapted to be rigidly connected to the towing frame, and a linkage coupled to the attachment frame. A row unit frame has a forward end coupled to the linkage to permit vertical pivoting movement of the row unit frame relative to the attachment frame. A closing-wheel assembly includes a support arm having a leading end coupled to the row unit frame, and a hub assembly mounted at a trailing end of the support arm. The hub assembly has a wheel-fastening mechanism with one or more removable fasteners. The closing-wheel assembly also includes a closing wheel connected to the hub assembly with the one or more removable fasteners such that the closing wheel is interchangeable with different types of modular closing wheels.

In accordance with another embodiment, an agricultural row unit includes a towing frame for being coupled to a tractor, an attachment frame adapted to be rigidly connected to the towing frame, and a linkage coupled to the attachment frame. A row unit frame has a forward end coupled to the linkage to permit vertical pivoting movement of the row unit frame relative to the attachment frame. A closing-wheel assembly includes a support arm having a leading end coupled to the row unit frame, and a hub assembly mounted at a trailing end of the support arm. The hub assembly has a wheel-fastening mechanism with one or more removable fasteners. The closing-wheel assembly also includes a first closing wheel connected to the hub assembly with the one or more removable fasteners, the first closing wheel being interchangeable with a second closing wheel of a different type. The second closing wheel is connected to the hub assembly solely with the same one or more removable fasteners.

In accordance with yet another embodiment, an agricultural row unit includes an attachment frame adapted to be rigidly connected to a towing frame, a linkage pivotably coupled to the attachment frame, and a row unit frame having a forward end coupled to the linkage to permit vertical pivoting movement of the row unit frame relative to the attachment frame. The agricultural row unit further includes a closing-wheel assembly having a support arm with a leading end coupled to the row unit frame, a first hub assembly mounted at a trailing end of the support arm with a first wheel-fastening mechanism with a first removable fastener, and a first closing wheel connected to the first hub assembly with the first removable fastener. The first closing wheel is interchangeable with a replacement closing wheel of a different type than the first closing wheel, the replacement closing wheel being connectable to the first hub assembly solely with the first removable fastener. A second hub assembly is mounted symmetrically relative to the first hub assembly at the trailing end of the support arm, the second hub assembly having a second wheel-fastening mechanism with a second removable fastener. A second closing wheel is connected to the second hub assembly with the second removable fastener, the second closing wheel being interchangeable with the replacement closing wheel. The replacement closing wheel is connectable to the second hub assembly solely with the second removable fastener.

### BRIEF DESCRIPTION OF THE DRAWINGS

The invention may best be understood by reference to the following description taken in conjunction with the accompanying drawings, in which:

FIG. 1 is a perspective view of an agricultural row unit.

FIG. 2A is a right-perspective view of a modular closing-wheel assembly having two toothed wheels.

FIG. 2B is a front view of the modular closing-wheel assembly having two semi-pneumatic wheels.

FIG. 2C is a left-perspective view of the modular closing-wheel assembly having a toothed wheel and a semi-pneumatic wheel.

FIG. 3A is an exploded view of a closing-wheel assembly having a toothed wheel.

FIG. 3B is an assembled view of the closing-wheel assembly of FIG. 3A.

FIG. 4A is an exploded view of a closing-wheel assembly having a semi-pneumatic wheel.

FIG. 4B is an assembled view of the closing-wheel assembly of FIG. 4A.

FIG. 5 is an exploded view of a hub assembly.

FIG. 6 is a cross-sectional view of the closing-wheel assembly of FIG. 3A.

FIG. 7 is an exploded view of a closing-wheel assembly in accordance with an alternative embodiment.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

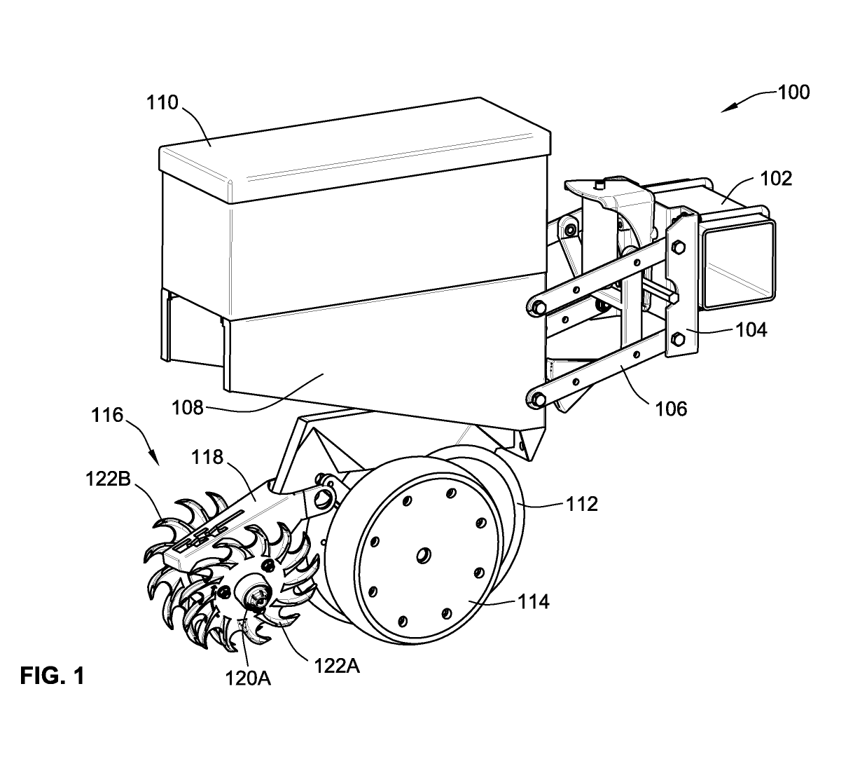

Turning now to the drawings and referring first to FIG. 1, an agricultural row unit 100 includes a towing frame 102 for being coupled to a tractor, and an attachment frame 104 that is rigidly connected to the towing frame 102. A parallel-bar linkage 106 is coupled to the attachment frame 104, and a row unit frame 108 has a forward end coupled to the linkage 106 for permitting vertical pivoting movement of the row unit frame 108 relative to the attachment frame 104. A planter bin 110 is mounted on the row unit frame 110 for carrying, for example, seeds, fertilizer, and/or chemicals that are dispensed during a planting operation.

A cutting wheel 112 is coupled to the row unit frame 108, in a forward position relative to a gauge wheel 114 and a closing-wheel assembly 116. The cutting wheel 112 is generally a coulter wheel that penetrates the soil to form a furrow or seed slot in preparation for the planting operation. However, other furrow-opening devices may be used, such as a V-opener that is formed by a pair of tilted coulter wheels that converge at their lower ends.

The gauge wheel 114 is coupled to the row unit frame 108, in a position located between the cutting wheel 112 and the closing-wheel assembly 116. The gauge wheel 114 determines the furrow depth, based on, for example, the desired planting depth for the seed and the height of introduction of fertilizer.

The closing-wheel assembly 116 has a support arm 118, a hub assembly 120A, and a pair of closing wheels 122A, 122B. The support arm 118 has a leading end that couples the hub assembly 120A to the row unit frame 108. The hub assembly 120A is mounted at a trailing end of the support arm 118 and includes a wheel-fastening mechanism (described below) with one or more removable fasteners. The closing wheels 122A, 122B close the furrow by distributing loosened soil into the furrow. The closing operation is generally performed after seed has been deposited in the furrow and fertilizer has been deposited adjacent to the furrow.

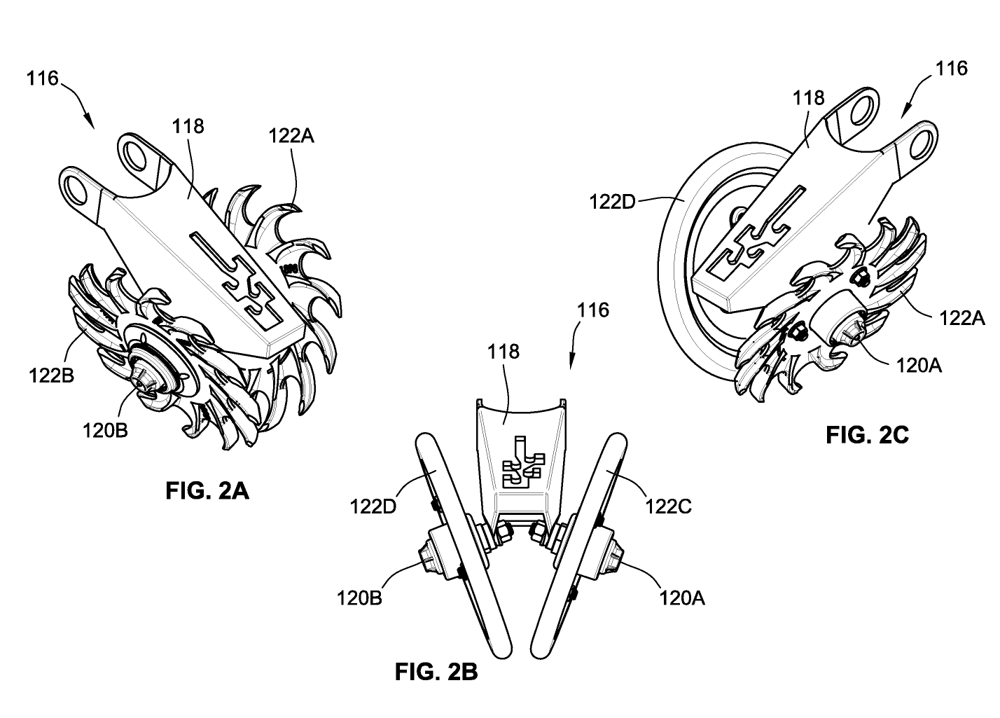

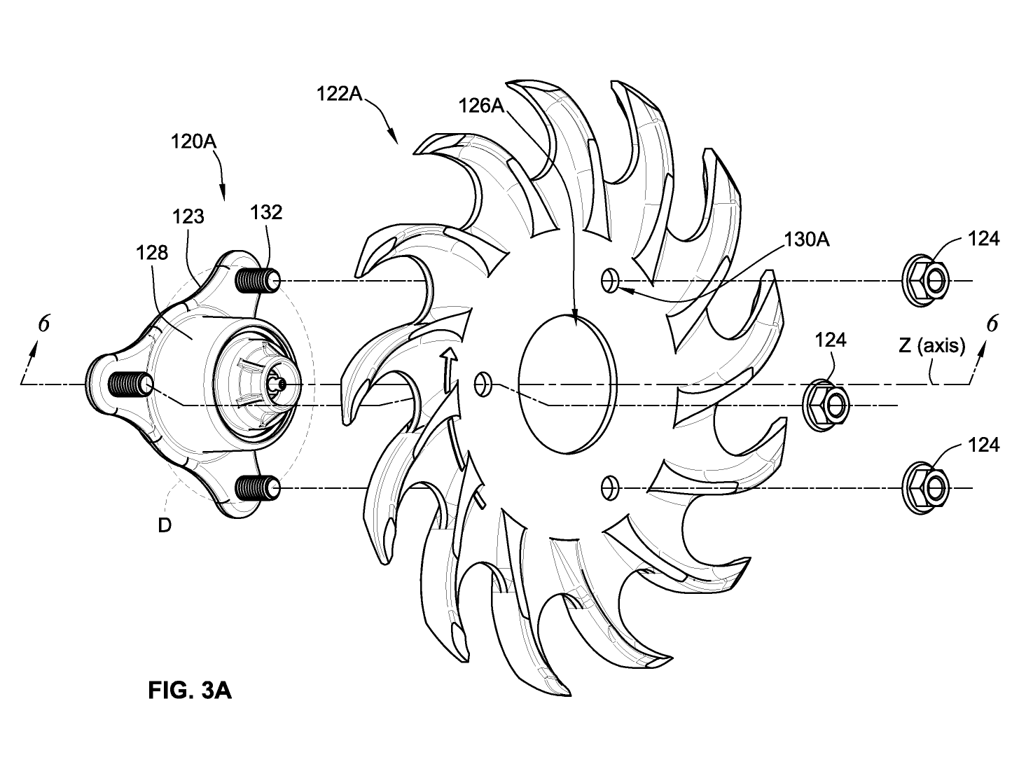

Referring to FIGS. 2A-2C, the closing-wheel assembly 116 is a modular assembly in which interchangeable closing wheels 122A-122D can be mounted. The closing wheels 122A-122D may be selected from a group of different types of wheels, including, e.g., a rubber semi-pneumatic wheel, a cast iron wheel, and a toothed wheel. The cast iron wheel may have a narrow smooth edge to produce high pressure. The toothed wheel may be a Dawn Curvetine™ closing wheel.

The closing-wheel assembly 116 has a right hub assembly 120A and a left hub assembly 120B. According to this embodiment, the right and left hub assemblies 120A, 120B are identical and symmetrically coupled to the support arm 118. However, in other embodiments, the right and left hub assemblies 120A, 120B can be different from each other and/or coupled in a non-symmetrical manner to the support arm 118. Alternatively, only one hub assembly can be used, with a respective closing wheel mounted thereto.

The closing wheels 122A-122D include a right closing wheel 122A in the form of a toothed wheel, a left closing wheel 122B also in the form of a toothed wheel, a right closing wheel 122C in the form of a semi-pneumatic wheel, and a left closing wheel 122D also in the form of a semi-pneumatic wheel. While in the illustrated embodiment the right and left toothed wheels 122A, 122B are identical to each other and the right and left semi-pneumatic wheels 122C, 122D are identical to each other, in alternative embodiments each of the closing wheels 122A-122D can be different from each other.

However, regardless of whether the closing wheels 122A-122D are different from each other, the closing-wheel assembly 116 is adapted to receive any of the closing wheels 122A-122D on any of the hub assemblies 120A. 120B, without any adaptation or modification to the closing-wheel assembly 116 except for exchanging one of the closing wheels 122A-122D for another one of the closing wheels 122A-122D (e.g., exchanging the right toothed wheel 122A with the right semi-pneumatic wheel 122C). For example, in FIG. 2A the closing-wheel assembly 116 includes two toothed wheels 122A, 122B., in FIG. 2B the closing-wheel assembly 116 includes two semi-pneumatic wheels 122C, 122D, and in FIG. 2C the closing-wheel assembly 116 includes one toothed wheel 122A and one semi-pneumatic wheel 122C. The exchange between one type of wheel, e.g., the right toothed wheel 122A, and another type of wheel, e.g., the right semi-pneumatic wheel 122C, is achieved using the same procedure and tools. In other words, no special tools or procedure is required for mounting one wheel than for mounting another wheel.

This type of modular interchangeability is extremely beneficial, for example, when varying soil conditions, type of crop, or varying tillage methods require quick and easy replacement of closing wheel. A farmer can change one type of closing wheel to another type of closing wheel, on the fly and without special additional tools or components. For example, the farmer may begin a planting operation with a first type of closing wheel that is best suited for dry soil conditions, which is less likely to adhere to the closing wheel. However, if weather conditions change during the planting operation such that soil “stickiness” is affected, e.g., rain changes dry soil into mud, the farmer will likely desire to change to a second type of closing wheel that is better suited for wet soil, which is more likely to adhere to the closing wheel.

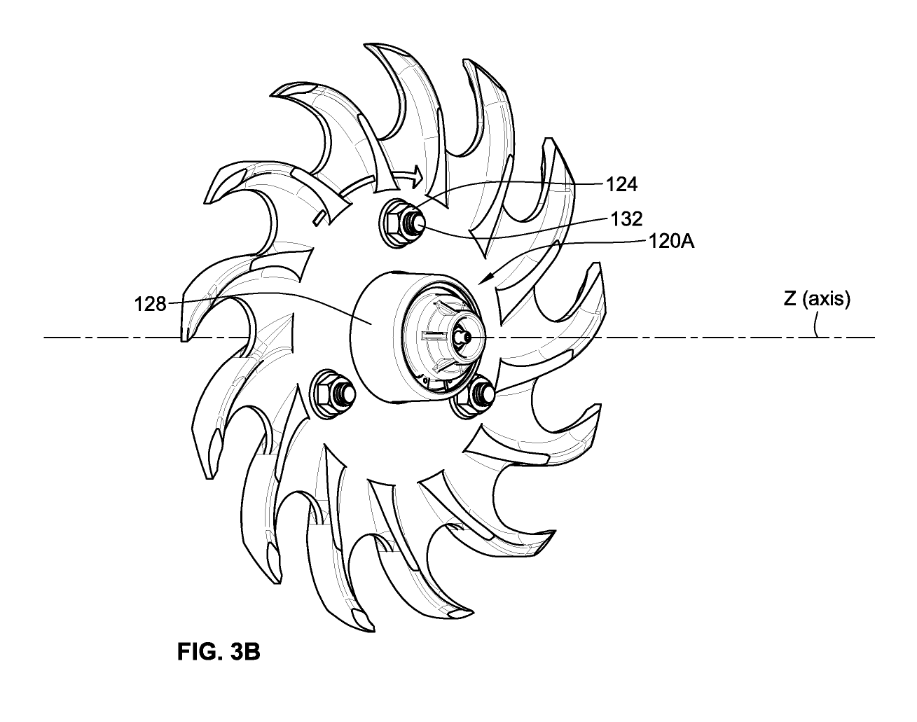

Referring to FIGS. 3A and 3B, the right toothed wheel 122A is mounted to a main hub 123 of the right hub assembly 120A via a wheel-fastening mechanism having a plurality of fastening nuts 124. To mount the right toothed wheel 122A to the right hub assembly 120A, a central hub hole 126A of the right toothed wheel 122A is inserted through a central receiving section 128 of the right hub assembly 120A. Simultaneously, three mounting holes 130A of the right toothed wheel 122A are inserted through respective ones of a plurality of threaded shafts 132 of the right hub assembly 120A.

The nuts 124 are fastened, respectively, to the threaded shafts 132 for retaining the right toothed wheel 122A securely in place relative to the right hub assembly 120A. As illustrated, the nuts 124 are arranged in a concentric arrangement around a rotational axis Z of the hub assembly 120A

Optionally, the threaded shafts 13 are press-in studs that are inserted through a back surface of the main hub 123. The press-in studs are inserted and received through respective holes of a bolt circle D that is coaxial with the rotational axis Z of the hub assembly 120A.

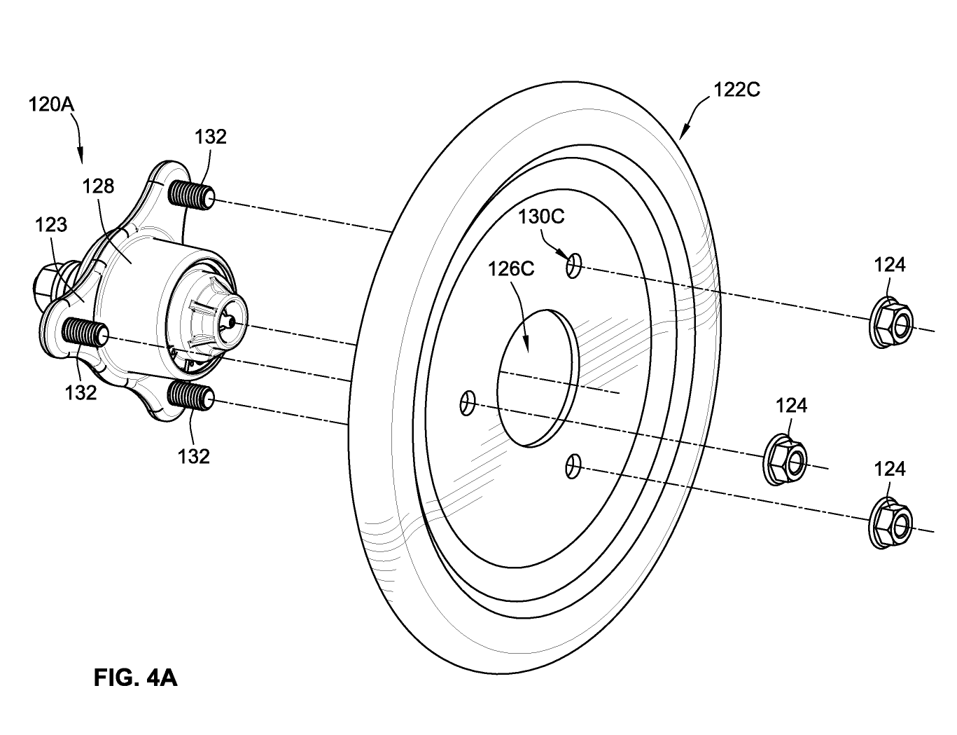

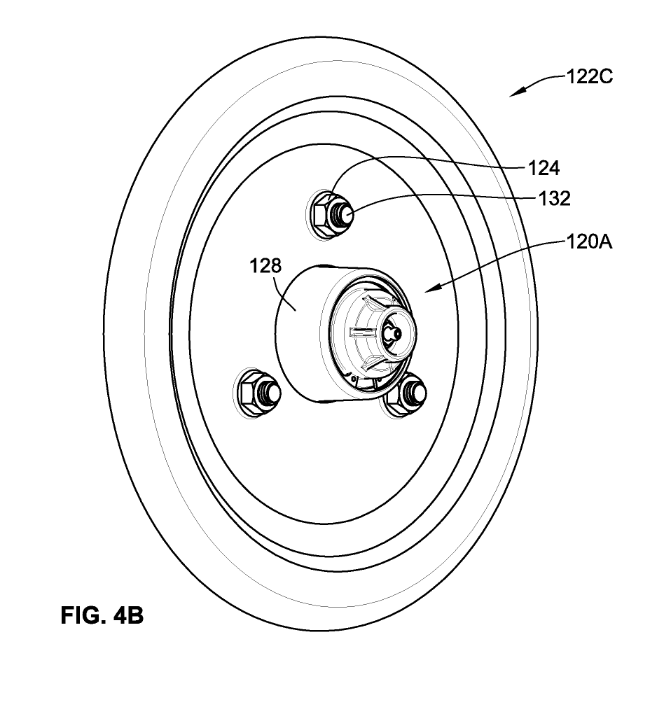

Referring to FIGS. 4A and 4B, the right semi-pneumatic wheel 122C has replaced the right toothed wheel 122A on the right hub assembly 120A. The right semi-pneumatic wheel 122C has a central hub hole 126C similar, if not identical, to the central hub hole 126A of the right toothed wheel 122A. The right semi-pneumatic wheel 122C also has three mounting holes 130C that are similar, if not identical, to the three mounting holes 130A of the right toothed wheel 122A.

The mounting configuration for each of the two different types of closing wheels—the toothed wheel 122A and the semi-pneumatic wheel 122C—is identical. Specifically, the mounting configuration refers to the central hub holes 126A, 126C, the mounting holes 130A, 130C, the central receiving section 128, the threaded shafts 132, and the nuts 124. In alternative examples, the mounting configuration does not have to be identical for each different type of closing wheel, but the mounting configuration must be such that the different types of closing wheel can be exchanged without requiring additional tools or components.

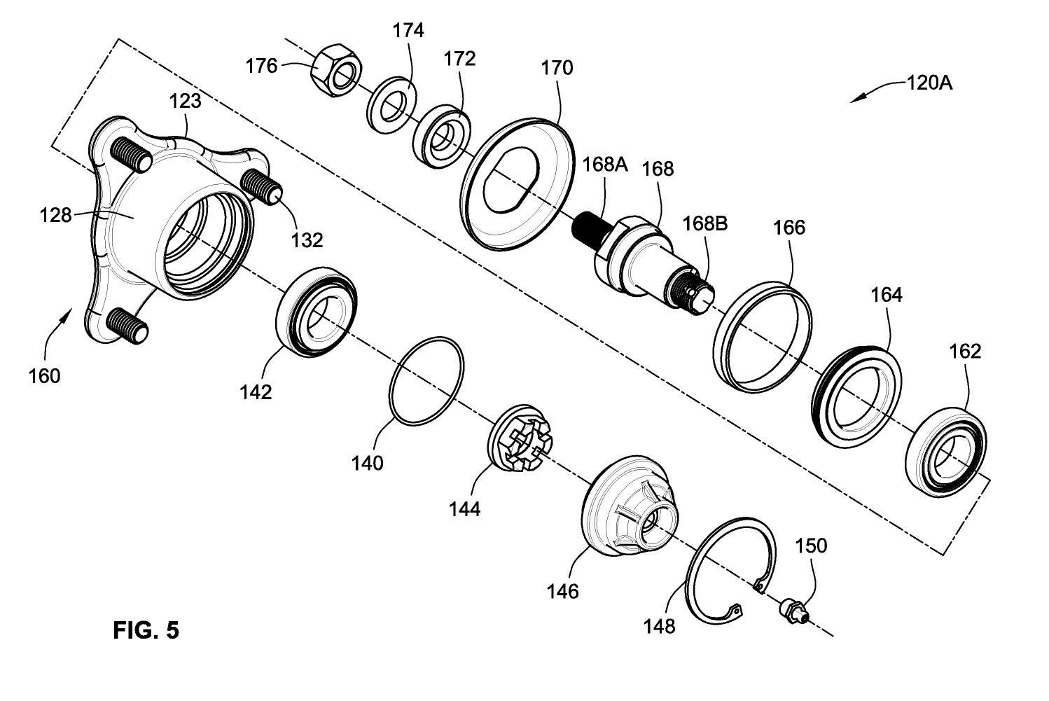

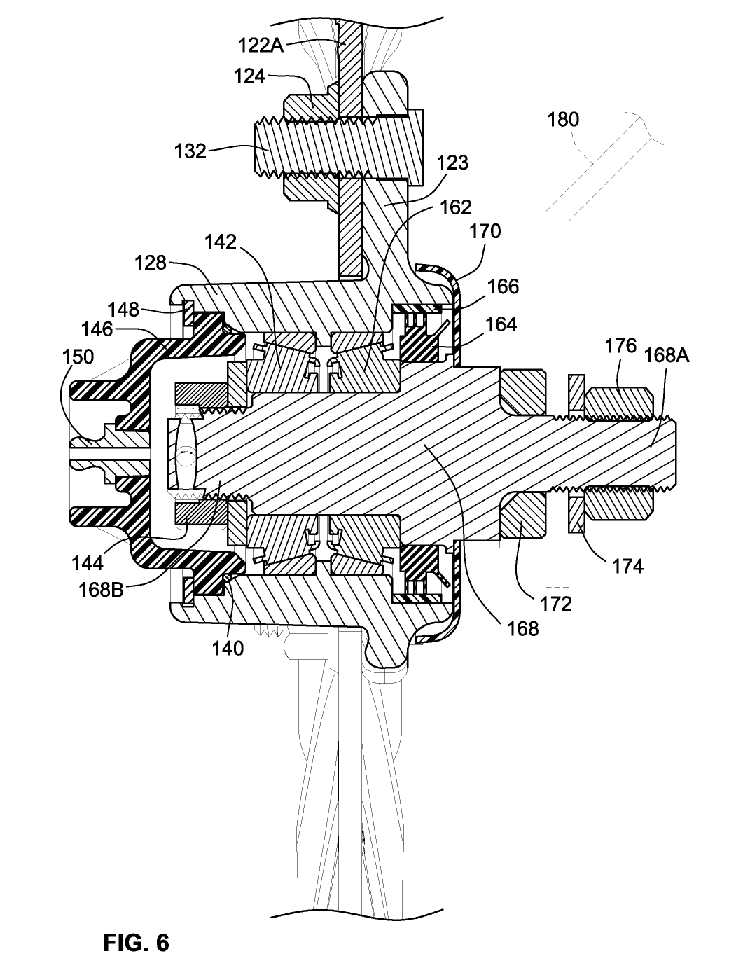

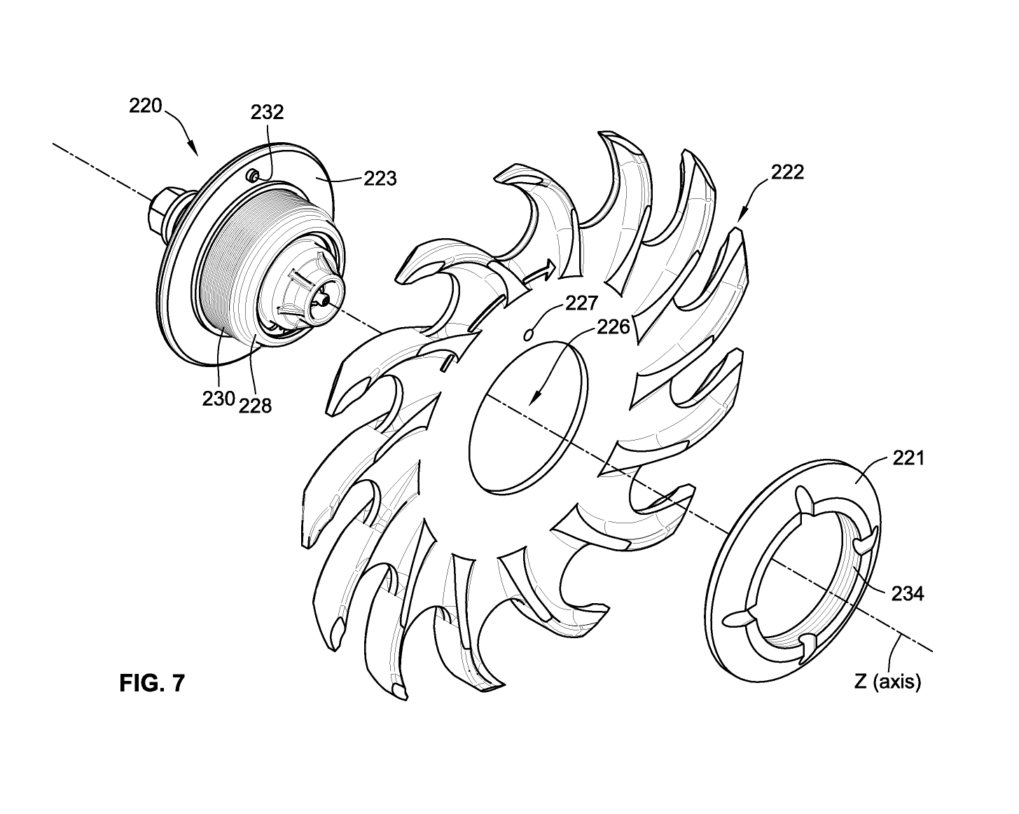

Referring to FIGS. 5 and 6, according to an exemplary embodiment, the main hub 123 of the right hub assembly 120A has a plurality of front components that are received internally within the central receiving section 128. Specifically, the central receiving section 128 receives, sequentially, a front grease seal 140 is followed by a front bearing 142, a shaft nut 144, a grease zert protective housing 146, a housing retaining ring 148, and a grease zert 150.

The right hub assembly 120A further includes a plurality of rear components that are mounted on a rear surface 160 of the main hub 123. These components include a rear bearing 162, a rear grease seal 164, and a rear ring 166. The rear ring 166 is mounted to provide a new smooth surface against which the rear grease seal 164 can rub. Optionally, one or more of the front bearing 142 and the rear bearing 162 is a tapered roller bearing.

The rear components further include a main shaft 168 and a protective dust/grease boot 170. The protective boot 170 prevents exposure of the front bearing 142 and the rear bearing 162 to environmental contaminants when connecting the closing wheel 122A to the hub assembly 120A.

The rear components are secured to the main hub 123 via a first nut 172, which is fastened to a large threaded shaft 168A of the main shaft 168. A washer 174 and a second nut 176 are used to help secure the right hub assembly 120A to the support arm 118. For example, as shown in FIG. 6, the large threaded shaft 168A is inserted through a receiving hole of a planar surface 180 of the support arm 118. The planar surface 180 is located between the first nut 172 and the washer 174, with the second nut 176 being threaded at the end of the large threaded shaft 168A.

The main shaft 168 further includes a small threaded shaft 168B that is fastened to an internally threaded hole of the shaft nut 144 (see FIG. 6). The fastened connection between the main shaft 168 and the shaft nut 144 secures, in part, along with the housing retaining ring 148, the front components in place relative to the main hub 123.

Referring now to FIG. 7, a hub assembly 220 includes a single fastener in the form of a knock-off nut 221. The hub assembly 220 includes a main hub 223 having a central receiving section 228, which has an external thread 230 along its exterior periphery. The hub assembly 220 further includes an anti-rotational element 232 located along a front surface of the main hub 223. In the illustrated embodiment, the anti-rotational element 232 is in the form of a small protruding shaft extending from the front surface of the main hub 223.

A closing wheel 222 has a central hub hole 226 and an anti-rotational hole 227. To mount the closing wheel 222 to the hub assembly 220, the central hub hole 226 is inserted through the central receiving section 228. The anti-rotational hole 227 is aligned and inserted through the anti-rotational element 232. The connection between the anti-rotational hole 227 and the anti-rotational element 232 prevents rotation of the closing wheel 222 relative to a rotational axis Z of the hub assembly 220.

To secure in place the closing wheel 222 relative to the hub assembly 220, the knock-off nut 221 is fastened to the central receiving section 228, by aligning the knock-off nut 221 with the rotational axis Z and threading an internal thread 234 with the matching external thread 232 of the main hub 223. According to one example, the knock-off nut 221 has a course screw pitch. According to another example, the knock-off nut 221 has both left-handed and right-handed threads to prevent loosening of the knock-off nut during a farming operation.

To remove the closing wheel 222 from the hub assembly 220, the knock-off nut 221 is first removed, followed by the removal of the closing wheel 222. Then, a different closing wheel is positioned on the main hub 223 and secured in place with the knock-off nut 221.

It will be evident to those skilled in the art that the invention is not limited to the details of the foregoing illustrated embodiment and that the present invention may be embodied in other specific forms without departing from the spirit or essential attributes thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An agricultural row unit comprising:
a towing frame for being coupled to a tractor;
an attachment frame adapted to be rigidly connected to the towing frame;
a linkage coupled to the attachment frame;
a row unit frame having a forward end coupled to the linkage to permit vertical pivoting movement of the row unit frame relative to the attachment frame; and
a closing-wheel assembly including
a support arm having a leading end coupled to the row unit frame,
a hub assembly mounted at a trailing end of the support arm and having a wheel-fastening mechanism with one or more removable fasteners, and
a closing wheel connected to the hub assembly with the one or more removable fasteners such that the closing wheel is interchangeable with different types of modular closing wheels.

2. The agricultural row unit of claim 1, wherein the closing wheel is selected from a group consisting of a rubber semi-pneumatic wheel type, a cast iron wheel type, and a toothed wheel type.

3. The agricultural row unit of claim 1, wherein the hub assembly includes tapered roller bearings.

4. The agricultural row unit of claim 1, wherein the hub assembly includes at least one bearing and a bearing cover, the bearing cover being mounted between the bearing and the one or more removable fasteners such that the bearing cover prevents exposure of the bearing to environmental contaminants when connecting the closing wheel to the hub assembly.

5. The agricultural row unit of claim 1, wherein the one or more removable fasteners includes a plurality of press-in studs for connecting the closing wheel to the hub assembly, the press-in studs being received in respective holes of a bolt circle that is coaxial with a rotational axis of the hub assembly.

6. The agricultural row unit of claim 1, wherein the one or more removable fasteners are arranged in a concentric arrangement around a rotational axis of the hub assembly.

7. The agricultural row unit of claim 1, wherein the one or more removable fasteners includes a single knock-off nut centrally aligned with a rotational axis of the hub assembly.

8. The agricultural row unit of claim 7, wherein the knock-off nut has a course screw pitch.

9. The agricultural row unit of claim 7, wherein the knock-off nut includes both left-handed and right-handed threads to prevent loosening of the knock-off nut during operation.

10. The agricultural row unit of claim 1, wherein the one or more removable fasteners includes a single removable fastener for connecting the closing wheel to the hub assembly.

11. The agricultural row unit of claim 1, wherein the closing-wheel assembly includes a second hub assembly with a second closing wheel, the second hub assembly being symmetrically mounted, relative to the hub assembly, on an opposite side of the trailing end of the support arm, the second closing wheel being interchangeable with the different types of closing wheels.

12. The agricultural row unit of claim 11, wherein the second closing wheel is the same type as the closing wheel.

13. The agricultural row unit of claim 1, wherein the hub assembly includes an anti-rotational element for preventing rotation of the closing wheel relative to a rotational axis of the hub assembly.

14. An agricultural row unit comprising:
a towing frame for being coupled to a tractor;
an attachment frame adapted to be rigidly connected to the towing frame;
a linkage coupled to the attachment frame;
a row unit frame having a forward end coupled to the linkage to permit vertical pivoting movement of the row unit frame relative to the attachment frame; and
a closing-wheel assembly including
a support arm having a leading end coupled to the row unit frame,
a hub assembly mounted at a trailing end of the support arm and having a wheel-fastening mechanism with one or more removable fasteners, and
a first closing wheel connected to the hub assembly with the one or more removable fasteners, the first closing wheel being interchangeable with a second closing wheel of a different type, the second closing wheel being connected to the hub assembly solely with the same one or more removable fasteners.

15. The agricultural row unit of claim 14, wherein the first closing wheel and the second closing wheel are selected from a group consisting of a rubber semi-pneumatic wheel type, a cast iron wheel type, and a toothed wheel type.

16. The agricultural row unit of claim 14, wherein the one or more removable fasteners includes a single knock-off nut centrally aligned with a rotational axis of the hub assembly.

17. The agricultural row unit of claim 14, wherein the one or more removable fasteners are threaded nuts arranged in a concentric arrangement around a rotational axis of the hub assembly, the threaded nuts being received on respective threaded studs.

18. An agricultural row unit comprising:
an attachment frame adapted to be rigidly connected to a towing frame;
a linkage pivotably coupled to the attachment frame;
a row unit frame having a forward end coupled to the linkage to permit vertical pivoting movement of the row unit frame relative to the attachment frame; and
a closing-wheel assembly including
a support arm having a leading end coupled to the row unit frame,
a first hub assembly mounted at a trailing end of the support arm and having a first wheel-fastening mechanism with a first removable fastener,
a first closing wheel connected to the first hub assembly with the first removable fastener, the first closing wheel being interchangeable with a replacement closing wheel of a different type than the first closing wheel, the replacement closing wheel being connectable to the first hub assembly solely with the first removable fastener,
a second hub assembly symmetrically mounted relative to the first hub assembly at the trailing end of the support arm, the second hub assembly having a second wheel-fastening mechanism with a second removable fastener, and
a second closing wheel connected to the second hub assembly with the second removable fastener, the second closing wheel being interchangeable with the replacement closing wheel, the replacement closing wheel being connectable to the second hub assembly solely with the second removable fastener.

19. The agricultural row unit of claim 18, wherein each of the first closing wheel, the second closing wheel, and the replacement closing wheel is selected from a group consisting of a rubber semi-pneumatic wheel type, a cast iron wheel type, and a toothed wheel type.

20. The agricultural row unit of claim 18, wherein at least one of the first removable fastener and the second removable fastener is a knock-off nut centrally aligned with a respective rotational axis of the first hub assembly and the second hub assembly.
